(19) United States
(12) Patent Application Publication
(10) Pub. No.: US 2022/0312667 A1
(43) Pub. Date: Oct. 6, 2022

(54) FOLIAGE-PROCESSING DEVICE MOVABLE OVER LAND IN A DIRECTION OF TRAVEL AS WELL AS HARVESTER COMPRISING A FOLIAGE-PROCESSING DEVICE

(71) Applicant: Ploeger Oxbo Europe B.V., Roosendaal (NL)

(72) Inventor: Cornelius Johannes Maria VAN BEEK, Roosendaal (NL)

(21) Appl. No.: 17/594,983

(22) PCT Filed: May 19, 2020
(86) PCT No.: PCT/NL2020/050319

§ 371 Date: Nov. 4, 2021

(30) Foreign Application Priority Data
May 29, 2019 (NL) 2023237

(51) Int. Cl. A01D 33/06; A01D 23/02

(52) U.S. Cl. CPC A01D 33/06; A01D 23/02; A01D 2023/026

(57) ABSTRACT

The invention relates to a foliage-processing device movable over land in a direction of travel for foliage of tuberous plants growing in rows on the land, wherein the foliage-processing device is provided with:
at least one haulm topper provided with arms rotating about a rotation axis with which the haulm is to be broken up and with which parts of the broken-up haulm are to be led away in a direction not directed towards the land;
at least one haulm puller provided with at least two rollers rotating opposite to one another between which the haulm is be gripped, and is to be pulled away in a direction not directed towards the land;
at least one discharge mechanism with which broken-up and pulled haulm is to be set down next to a row or between the rows of the tuberous plants growing on the land.

The invention relates to a foliage-processing device, movable over land in a direction of travel, for foliage of tuberous plants growing in rows on the land, wherein the foliage-processing device is provided with:
at least one haulm topper provided with arms rotating about a rotation axis with which the haulm is to be broken up and with which parts of the broken-up haulm are to be led away in a direction not directed towards the land;
at least one haulm puller provided with at least two rollers rotating opposite to one another between which the haulm is be gripped, and is to be pulled away in a direction not directed towards the land;
at least one discharge mechanism with which broken-up and pulled haulm is to be set down next to a row or between the rows of the tuberous plants growing on the land.

The invention also relates to a harvester comprising a foliage-processing device. Viewed in the direction of travel, the harvester may be provided with the foliage-processing device at the front. Finally, the invention relates to the use of a foliage-processing device or a harvester.

A foliage-processing device of this kind is known from WO2018/012975. By means of the known foliage-processing device it is possible for rows or ridges in which tuberous plants are growing to be made free or almost free from haulm, so that the tuberous plants can be harvested directly after carrying out foliage processing, wherein the amount of haulm in a harvester is minimal.

It is an object of the present invention to provide a foliage-processing device with which the results relating to making the rows on the land haulm-free are at least equal to the known foliage-processing device and under certain circumstances, such as with relatively high, much, tough and/or green haulm, are even improved.

This object is achieved with a foliage-processing device as defined in claim 1.

The foliage-processing device movable over land in a direction of travel is configured for carrying out operations for processing foliage of tuberous plants growing in rows on the land. The foliage-processing device is among other things provided with:
at least one haulm topper provided with arms rotating about a rotation axis with which the haulm is to be broken up and with which parts of the broken-up haulm are to be led away in a direction not directed towards the land;
at least one haulm puller provided with at least two rollers rotating opposite to one another between which the haulm is be gripped, and is to be pulled away in a direction not directed towards the land;
at least one discharge mechanism with which broken-up and pulled haulm is to be set down next to a row or between the rows of the tuberous plants growing on the land. Moreover, viewed in the direction of travel, the haulm puller is mounted before the discharge mechanism, and the rotation axis of the haulm topper, viewed in the direction of travel, is mounted before the haulm puller.

By means of the configuration wherein the haulm puller is mounted between the discharge mechanism and the haulm topper, the broken-up haulm can be led away from the haulm topper in the direction of the discharge mechanism and the haulm pulled by means of the haulm puller can simply be led away to the discharge mechanism mounted after it. Owing to this configuration, the haulm puller may be mounted relatively close to the discharge mechanism, optionally even partly overlapping, so that the pulled haulm is moved towards the discharge mechanism by means of the haulm puller itself. In this configuration the haulm topper may also contribute to the movement of the haulm from the haulm puller to the discharge mechanism by inducing air currents by means of the arms of the haulm topper shaped for this purpose, with which both the broken-up haulm from the haulm topper and the pulled haulm from the haulm puller are to be moved in the direction of the discharge mechanism with which broken-up and pulled haulm is to be set down next to a row or between the rows of the tuberous plants growing on the land. The arms may be shaped in such a way that the resultant cut/broken-up haulm product is moved substantially opposite to the direction of travel as well as in a direction not directed towards the land. The backward conveyance of the loose haulm, with respect to the direction of travel, may be further promoted and streamlined by guide plates. Then by discharging, by means of the discharge mechanism, the haulm coming from the haulm topper and the haulm puller between the rows, pick-up of haulm during lifting/digging up is greatly reduced, which means less to no stoppages, as well as a cleaner product at a higher harvesting capacity. By means of this foliage-processing device, the haulm processing and the harvesting activities can be carried out in a more environmentally friendly and flexible manner. This foliage-processing device is particularly suitable for rows with relatively high haulm and/or relatively much, tough and/or green haulm, because by means of the haulm topper, the haulm can be reduced relatively effectively and strongly, so that the haulm puller is better able to remove the (short) haulm left behind.

In one aspect, the distance between the rotation axis of the haulm topper and the discharge mechanism is smaller than the diameter defined by the working circle round the rotation axis of a longest arm of the arms of the haulm topper. In this way, a compact foliage-processing device is provided, wherein the haulm topper, the haulm puller and the discharge mechanism are mounted relatively close to each other, so that haulm coming from the haulm topper and the haulm puller can be conveyed to the discharge mechanism relatively easily without other aids. Moreover, owing to the limited distance, the air flow to be generated by means of the arms of the haulm topper can support and/or promote transport from the haulm topper and/or the haulm puller to the discharge mechanism in an optimum manner.

It is possible for the lengths of the arms of the haulm topper to be identical, so that each diameter of the identical working circle determines the aforesaid distance.

The foliage-processing device may further comprise a housing, in which the haulm puller, the haulm topper and the discharge mechanism are mounted. By means of the housing, haulm transport from the haulm puller and the haulm topper to the discharge mechanism can be improved, because the housing is shaped in such a way that it functions as a haulm guide to the discharge mechanism. The flow to be generated by means of the arms of the haulm topper can also be better channelled in the direction of the discharge mechanism by means of the housing. The housing also comprises the function of increasing safety for users, in that the housing can block access from outside to the haulm topper and the haulm puller. Furthermore, the haulm topper, haulm puller and discharge mechanism can be protected by the housing against the effects of the weather. The housing may be an at least partially openable housing for inspection of the haulm topper, haulm puller and discharge mechanism as well as to provide temporary access for carrying out maintenance thereon. Optionally, a flow generating mechanism is to be provided in the foliage-processing device, with which an air stream is to be generated in the housing for further promoting transport of broken-up and pulled haulm to the discharge mechanism.

In another aspect, a number of arms of a haulm topper may comprise different lengths, so that at least one first arm of the arms defines a smaller working circle than a second arm of the haulm topper. The lengths of the arms of the haulm topper may for example be adjusted to the profile of a row formed by a potato ridge so that haulm on the potato ridge can be broken up in an optimum manner by the haulm topper. The arms of the haulm topper are also called flails or knives.

The foliage-processing device may be provided with a number of haulm toppers and haulm pullers for simultaneous removal of haulm from different rows/ridges. The haulm toppers may be rotatable about the rotation axis by means of a common drive shaft.

As stated, the invention further relates to a harvester provided with a foliage-processing device described above, wherein the aspects and advantages of the foliage-processing device as described above are also applicable to the harvester and consequently are not repeated here.

The aspects described above will be explained hereunder on the basis of embodiment examples in combination with the figures. The invention is not, however, limited to the embodiment example described hereunder. Rather, a number of variants and modifications are possible, which also make use of the idea of the invention and consequently fall within the range of protection. In particular, it is possible for the features/aspects that are only mentioned in the description and/or are shown in the figures to be combined with the features in the claims in so far as compatible.

The foliage-processing device will now be explained in more detail on the basis of embodiment examples that are illustrated in the figures, in which:

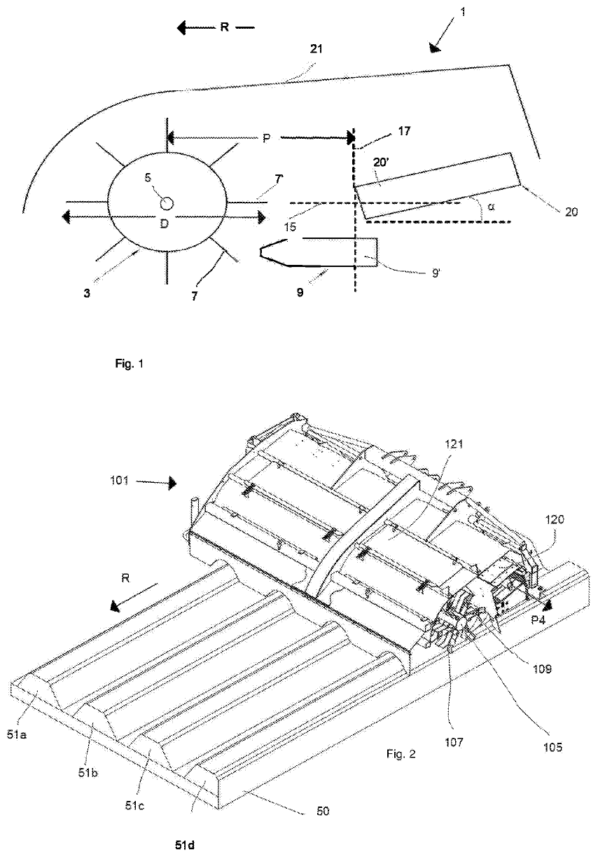

FIG. 1 shows schematically a side view of a foliage-processing device;

FIG. 2 shows a perspective view of a foliage-processing device;

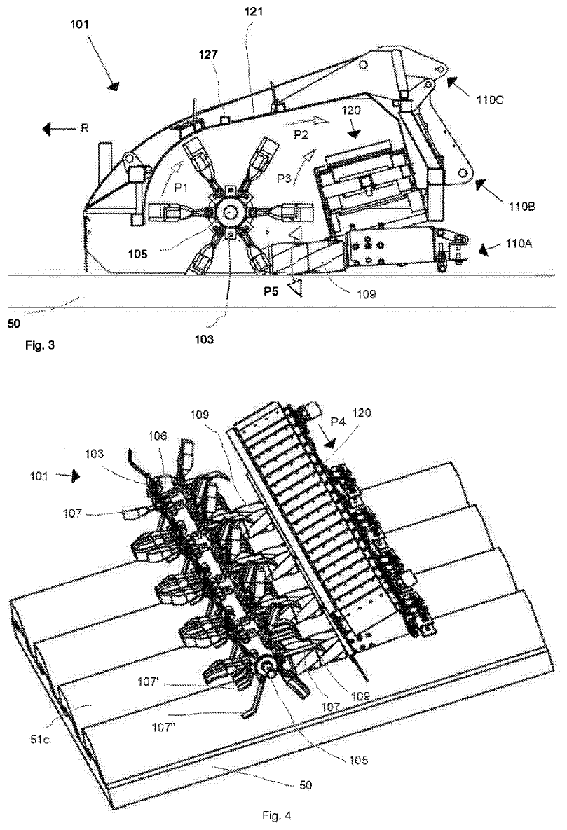

FIG. 3 shows a side view of the foliage-processing device shown in FIG. 2;

FIG. 4 shows a perspective view of parts of the foliage-processing device shown in FIG. 2.

In the figures, identical components are given the same reference signs.

FIGS. 1-4 show a foliage-processing device 1; 101 movable over land 50 in a direction of travel R, for foliage of tuberous plants (not shown) growing in rows 51a-d on the land 50. By means of the foliage-processing device 1; 101, the row 51a-d to be lifted can be made almost free from haulm, so that the amount of haulm in a harvester (not shown) is minimal, providing easier, quicker and better sieving of the soil in the harvester between the tubers, so that lifting and processing of the tubers can be improved considerably. The foliage-processing device 101 is provided with fastening means 110A (FIG. 3) with which the haulm rollers can be suspended on the foliage-processing device 1; 101 securely, flexibly and/or hinged (not shown). By means of the fastening points 110B, 110C, a harvester can be provided with the foliage-processing device 1; 101 at the front, viewed in the direction of travel.

The foliage-processing device 1; 101 is further provided with:
a haulm topper (or haulm shredder) 3; 103 provided with arms 7; 107 rotating about a rotation axis 5; 105, with which the haulm is to be broken up and with which parts of the broken-up haulm are to be led away in a direction not directed towards the land P1, P2;
a haulm puller 9; 109 provided with at least two rollers rotating opposite to one another between which the haulm is be gripped, and is to be pulled away in a direction not directed towards the land;
a discharge mechanism 20; 120 with which broken-up and pulled haulm is to be set down next to a row 51a-d or between the rows 51a-d of the tuberous plants growing on the land.

As clearly shown in FIGS. 1 and 3, viewed in the direction of travel, the haulm puller 9; 109 is mounted before the discharge mechanism 20; 120, and the rotation axis 5; 105 of the haulm topper 3; 103 is mounted before the haulm puller 9; 109, viewed in the direction of travel.

The rotation axis 5; 105 of the haulm topper 3; 103 extends substantially transversely to the direction of travel R. The foliage-processing device 101 is provided with a number of haulm toppers 103 and haulm pullers 109 mounted one after another transversely to the direction of travel, for simultaneous removal of haulm from different rows/ridges, wherein the haulm toppers are rotatable about the rotation axis 105 by means of a common drive shaft 106.

With the configuration in which the haulm puller 9; 109 is mounted between the discharge mechanism 20; 120 and the haulm topper 3; 103, broken-up haulm can be led away from the haulm topper 3; 103 in the direction of the discharge mechanism 20; 120 and haulm pulled by the haulm puller 9; 109 can simply be led away to the discharge mechanism 20; 120 mounted directly after it. With this configuration, the haulm puller 9; 109 may be mounted relatively close to the discharge mechanism, optionally even partly overlapping, as is also shown in the side views in FIGS. 1 and 3, so that the pulled haulm is moved by means of the haulm puller 9; 109 itself to the discharge mechanism 20; 120, without requiring supplementary mechanisms for this. In this way, a relatively simple foliage-processing device 1; 101 can be provided, which owing to the aforementioned haulm topper 3; 103 shows very good results with relatively much, high, tough and/or green haulm.

The haulm puller 9; 109 and the oppositely rotating rollers (see arrow P5 in FIG. 3) thereof may be configured as described in WO2018/012975.

As shown, to promote pick-up of haulm in operation, the discharge mechanism 20; 120 is, at least largely, positioned at a greater distance (height) with respect to the land than the rotation axis 5; 105 of the haulm topper 3; 103, which is shown with the dotted line 15 in FIG. 1, and the discharge mechanism 20; 120 extends substantially at an acute angle with respect to a horizontal plane, the angle α preferably being less than 45 degrees. Owing to this arrangement of the discharge mechanism 20; 120 and the end 9′ of the rollers of the haulm puller 9; 109, which, viewed in a longitudinal direction of foliage-processing device 1; 101 extending in the direction of travel R, is mounted overlapping with the end 20′ of the discharge mechanism 20; 120, which is indicated in FIG. 1 with the vertical dotted line 17, this means that haulm pulled by the haulm puller 9; 109 can be conveyed directly to the discharge mechanism 20; 120, as shown in FIG. 3 by arrow P3. The discharge mechanism 20; 120 is a conveyor belt with which broken-up and pulled haulm is to be set down in or opposite to a direction shown by arrow P4 next to a row 51a-d or between the rows 51a-d of the tuberous plants growing on the land. Optionally, the discharge mechanism 20; 120 may be provided with two conveyor belts (not shown), with which, viewed from the direction of travel R, haulm is to be set down on the left (opposite to arrow P4) and on the right (arrow P4) next to a row 51a-d or between the rows 51a-d of the tuberous plants growing on the land.

In the foliage-processing device 1; 101, the distance, shown by the letter P in FIG. 1, between the rotation axis 5; 105 of the haulm topper 3; 103 and the discharge mechanism 20; 120 is smaller than the diameter D defined by the working circle round the rotation axis 5; 105 of a longest arm 7′ of the arms 7 of the haulm topper 1; 101. In this way, a compact foliage-processing device 1; 101 is provided, wherein the haulm topper 3; 103, the haulm puller 9; 109 and the discharge mechanism 20; 120 are mounted relatively close to each other, so that haulm coming from the haulm topper 3; 103 and the haulm puller 9; 109 can be conveyed relatively easily, without other aids, to the discharge mechanism 20; 120. The foliage-processing device 1; 101 is also provided with a single housing 21; 121 in which the haulm puller 9; 109, the haulm topper 3; 103 and the discharge mechanism 20; 120 are located. By means of the housing 21; 121, haulm transport of the haulm puller 9; 109 and haulm topper 3; 103 can be improved, because the housing 21; 121 is shaped in such a way that it functions as a haulm guide to the discharge mechanism 20; 120.

The air flow to be generated by means of the arms 7; 107 of the haulm topper 3; 103 may also be directed better by means of the housing 21; 121 to support the transport of haulm from the haulm topper 3; 103 and/or from the haulm puller 9; 109.

In the foliage-processing device 101, a flow generating mechanism 127, for example a blower or fan, is mounted in the housing 121, with which an air flow is to be generated in the housing 121 for further promoting transport of broken-up and/or pulled haulm to the discharge mechanism 20; 120.

The arms 107 of the haulm topper 103 comprise different lengths as shown in FIG. 4, so that at least one first arm 107′ of the arms 107 defines a smaller working circle than a second arm 107″ of the haulm topper 103. The length of each arm 107 of the haulm topper 103 is adjusted to the profile of a row 51a-d formed by a potato ridge so that haulm on the potato ridge can be broken up in an optimum manner by means of the haulm topper 103.

1. A foliage-processing device movable over land in a direction of travel for foliage of tuberous plants growing in rows on the land, wherein the foliage-processing device is provided with:
at least one haulm topper provided with arms rotating about a rotation axis with which the haulm is to be broken up and with which parts of the broken-up haulm are to be led away in a direction not directed towards the land;
at least one haulm puller provided with at least two rollers rotating opposite to one another between which the haulm is be gripped, and is to be pulled away in a direction not directed towards the land;
at least one discharge mechanism with which broken-up and pulled haulm is to be set down next to a row or between the rows of the tuberous plants growing on the land,
characterized in that, viewed in the direction of travel, the haulm puller is mounted before the discharge mechanism and, viewed in the direction of travel, the rotation axis of the haulm topper is mounted before the haulm puller.

2. The foliage-processing device according to claim 1, wherein the distance between the rotation axis of the haulm topper and the discharge mechanism is less than the diameter defined by the working circle round the rotation axis of a longest arm of the arms of the haulm topper.

3. The foliage-processing device according to claim 1, wherein the haulm puller, the haulm topper and the discharge mechanism are located in a housing.

4. The foliage-processing device according to claim 3, wherein the foliage-processing device comprises a flow generating mechanism with which an air flow can be generated in the housing for promoting transport of broken-up and pulled haulm to the discharge mechanism.

5. The foliage-processing device according to claim 1, wherein a number of arms of a haulm topper comprise different lengths, so that at least one first arm of the arms defines a smaller working circle than a second arm of the haulm topper.

6. The foliage-processing device according to claim 1, wherein the discharge mechanism is, at least largely, located at a greater distance with respect to the land than the rotation axis of the haulm topper, and/or the discharge mechanism extends substantially at an acute angle with respect to a horizontal plane.

7. A harvester comprising the foliage-processing device according to claim 1.

8. The harvester according to claim 7, wherein, viewed in the direction of travel, the harvester is provided with the foliage-processing device at the front.

9. Use of a foliage-processing device according to claim 1.
